(19) United States
(12) Patent Application Publication
(10) Pub. No.: US 2006/0177339 A1
(43) Pub. Date: Aug. 10, 2006

(54) Horizontal type orbiting vane compressor

(75) Inventors: Seon-woong Hwang, Anyang-Si (KR); Dong-won Yoo, Seoul (KR)

Correspondence Address: GREENBLUM & BERNSTEIN, P.L.C., 1950 ROLAND CLARKE PLACE, RESTON, VA, 20191, US

(73) Assignee: LG Electronics Inc., Seoul (KR)

(21) Appl. No.: 11/208,722

(22) Filed: Aug. 23, 2005

(30) Foreign Application Priority Data
Feb. 4, 2005 (KR) 10-2005-0010703

(51) Int. Cl. F01C 20/18; F16N 13/20; F01C 1/02; F04C 2/00; F04C 14/18

(52) U.S. Cl. 418/59; 418/58; 418/30

(57) ABSTRACT

Disclosed herein is a horizontal type orbiting vane compressor having a horizontal structure. The horizontal type orbiting vane compressor comprises a horizontally disposed shell having an inlet tube and an outlet tube, a compression unit disposed in the shell at one side of a horizontally disposed rotary shaft such that the compression unit is rotated by a drive unit for compressing refrigerant gas, and an oil-supplying unit for supplying oil from an oil sump to an oil hole extending through the rotary shaft by an orbiting movement of an orbiting vane in the compression unit. When the horizontal type orbiting vane compressor is applied to an air conditioner, an outdoor unit of the air conditioner is greatly reduced in size.

### BACKGROUND OF THE INVENTION

1. Field of the Invention

The present invention relates to an orbiting vane compressor that is capable of forming compression chambers at the inside and the outside of a wrap of an orbiting vane as the wrap performs an orbiting movement in an operation space defined in a cylinder, and, more particularly, to a horizontal type orbiting vane compressor having a horizontal structure.

2. Description of the Related Art

Generally, an orbiting vane compressor is constructed to compress refrigerant gas introduced into a cylinder through an orbiting movement of an orbiting vane in the cylinder having an inlet port. Various types of orbiting vane compressors, which are classified based on their shapes, have been proposed.

FIG. 1 is a longitudinal sectional view illustrating the overall structure of a conventional rotary-type orbiting vane compressor. As shown in FIG. 1, a drive unit D and a compression unit P, which is disposed below the drive unit D, are mounted in a shell 1 while the drive unit D and the compression unit P are hermetically sealed. The drive unit D and the compression unit P are connected to each other via a vertical rotary shaft 6, which has an eccentric part 6a.

The drive unit D comprises: a stator 2 fixedly disposed in the shell 1; and a rotor 3 disposed in the stator 2 for rotating the rotary shaft 6, which vertically extends through the rotor 3, when electric current is supplied to the rotor 3.

The compression unit P comprises an orbiting vane 4 for performing an orbiting movement in a cylinder 5 by the eccentric part 6a of the rotary shaft 6. As the orbiting vane 4 performs the orbiting movement in the cylinder 5, refrigerant gas introduced into the cylinder 5 through an inlet port 51 is compressed. The cylinder 5 has an inner ring 52. Between the inner ring 52 and the inner wall of the cylinder 5 is defined an annular operation space 53. A wrap 40 of the orbiting vane 4 performs an orbiting movement in the operation space 53. As a result, compression chambers are formed at the inside and the outside of the wrap 40, respectively.

At the upper and lower parts of the compression unit P are disposed a main bearing 7 and a subsidiary bearing 7a, which support opposite ends of the rotary shaft 6, respectively. The subsidiary bearing 7a has a discharge chamber 8a, which is defined by a muffler 8. The discharge chamber 8a is connected to a pipe-shaped discharge channel 9, which extends vertically through the compression unit P and the main bearing 7, such that the compressed refrigerant gas is discharged into the shell 1 through the discharge channel 9.

Unexplained reference numeral 11 indicates an inlet tube, 12 an outlet tube, and 10a an Oldham's ring for preventing rotation of the wrap 40 of the orbiting vane 4.

When electric current is supplied to the drive unit D, the rotor 3 of the drive unit D is rotated, and therefore, the rotary shaft 6, which vertically extends through the rotor 3, is also rotated. As the rotary shaft 6 is rotated, the orbiting vane 4 attached to the eccentric part 6a of the rotary shaft 6 performs an orbiting movement.

As a result, the wrap 40 of the orbiting vane 4 performs an orbiting movement in the operation space 53 of the cylinder 5 to compress refrigerant gas introduced into the cylinder 5 through the inlet port 51 in the compression chambers formed at the inside and the outside of the wrap 40, respectively. The compressed refrigerant gas is discharged into the discharge chamber 8a through inner and outer outlet ports (not shown) formed at the cylinder 5 and the subsidiary bearing 7a. The discharged high-pressure refrigerant gas is guided into the shell 1 through the discharge channel 9. Finally, the compressed refrigerant gas is discharged out of the orbiting vane compressor through the outlet tube 12.

FIG. 2 is a plan view, in section, illustrating the compressing operation of the conventional orbiting vane compressor shown in FIG. 1.

As shown in FIG. 2, the wrap 40 of the orbiting vane 4 of the compression unit P performs an orbiting movement in the operation space 53 of the cylinder 5, as indicated by arrows, to compress refrigerant gas introduced into the operation space 53 through the inlet port 51. The orbiting movement of the wrap 40 of the orbiting vane 4 will be described hereinafter in more detail.

At the initial orbiting position of the wrap 40 of the orbiting vane 4 of the compression unit P (i.e., the 0-degree orbiting position), refrigerant gas is introduced into an inner suction chamber A1, which is disposed at the inside of the wrap 40, through the inlet port 51, and compression is performed in an outer compression chamber B2, which is disposed at the outside of the wrap 40, while the outer compression chamber B2 does not communicate with the inlet port 51 and an outer outlet port 53b. Refrigerant gas is compressed in an inner compression chamber A2, and at the same time, the compressed refrigerant gas is discharged out of the inner compression chamber A2.

At the 90-degree orbiting position of the wrap 40 of the orbiting vane 4 of the compression unit P, the compression is still performed in the outer compression chamber B2, and almost all the compressed refrigerant gas is discharged out of the inner compression chamber A2 through an inner outlet port 53a. At this stage, an outer suction chamber B1 appears so that refrigerant gas is introduced into the outer suction chamber B1 through the inlet port 51.

At the 180-degree orbiting position of the wrap 40 of the orbiting vane 4 of the compression unit P, the inner suction chamber A1 disappears. Specifically, the inner suction chamber A1 is changed into the inner compression chamber A2, and therefore, compression is performed in the inner compression chamber A2. At this stage, the outer compression chamber B2 communicates with the outer outlet port 53b. Consequently, the compressed refrigerant gas is discharged out of the outer compression chamber B2 through the outer outlet port 53b.

At the 270-degree orbiting position of the wrap 40 of the orbiting vane 4 of the compression unit P, almost all the compressed refrigerant gas is discharged out of the outer compression chamber B2 through the outer outlet port 53b, and the compression is still performed in the inner compression chamber A2. Also, compression is newly performed in the outer suction chamber B1. When the orbiting vane 4 of the compression unit P further performs the orbiting movement by 90 degrees, the outer suction chamber B1 disappears. Specifically, the outer suction chamber B1 is changed into the outer compression chamber B2, and therefore, the compression is continuously performed in the outer compression chamber B2. As a result, the wrap 40 of the orbiting vane 4 of the compression unit P is returned to the position where the orbiting movement of the orbiting vane 4 is initiated. In this way, a 360-degree-per-cycle orbiting movement of the wrap 40 of the orbiting vane 4 of the compression unit P is accomplished. The orbiting movement of the wrap 40 of the orbiting vane 4 of the compression unit P is performed in a continuous fashion.

The conventional rotary-type orbiting vane compressor with the above-stated construction is a vertical type orbiting vane compressor, which is vertically installed. When the vertical type orbiting vane compressor is installed in an outdoor unit of an air conditioner, the size of the outdoor unit is relatively increased, since the vertical type orbiting vane compressor occupies a relatively large installation space in the outdoor unit, and therefore, miniaturization of the outdoor unit is very difficult. On the other hand, a horizontal type orbiting vane compressor is horizontally mounted below a cooling fan of the outdoor unit of the air conditioner, and therefore, miniaturization of the outdoor unit is easily accomplished. Consequently, demand for horizontal type orbiting vane compressors is increasing. However, serious consideration must be given to an oil-supplying structure of the horizontal type orbiting vane compressor when the horizontal type orbiting vane compressor is designed.

### SUMMARY OF THE INVENTION

Therefore, the present invention has been made in view of the above problems, and it is an object of the present invention to provide a horizontal type orbiting vane compressor that is capable of forming compression chambers at the inside and the outside of a wrap of an orbiting vane as the wrap performs an orbiting movement in an operation space defined in a cylinder.

It is another object of the present invention to provide a horizontal type orbiting vane compressor that is capable of eliminating problems in connection with oil supply.

It is yet another object of the present invention to provide a horizontal type orbiting vane compressor that is capable of increasing the flow rate of oil through improvement of an oil-supplying structure.

In accordance with the present invention, the above and other objects can be accomplished by the provision of a horizontal type orbiting vane compressor comprising: a horizontally disposed shell having an inlet tube and an outlet tube; a compression unit disposed in the shell at one side of a horizontally disposed rotary shaft such that the compression unit is rotated by a drive unit for compressing refrigerant gas; and an oil-supplying unit for supplying oil from an oil sump to an oil hole extending through the rotary shaft by an orbiting movement of an orbiting vane in the compression unit.

Preferably, the rotary shaft is disposed such that opposite ends of the rotary shaft are rotatably supported by a main bearing and a subsidiary bearing, which are disposed at opposite sides of the compression unit, respectively, and the horizontal type orbiting vane compressor further comprises: a muffler disposed adjacent to outlet ports of the subsidiary bearing; and a discharge channel formed inside the muffler, the discharge channel extending though the compression unit and communicating with a discharge chamber defined by the muffler.

Preferably, the compression unit comprises: a cylinder having an operation space defined between an inner wall of the cylinder and an inner ring; and an orbiting vane having a wrap disposed in the operation space of the cylinder for performing an orbiting movement.

Preferably, the operation space is divided into inner and outer compression chambers by the wrap, and the cylinder has a pair of outlet ports, which communicate with the inner and outer compression chambers, respectively.

Preferably, the oil-supplying unit comprises: an oil pump for supplying oil from an oil sump to the rotary shaft; and oil inlet and outlet tubes disposed at opposite sides of the oil pump, respectively, the oil inlet tube being mounted in the oil sump for allowing oil to be introduced into the oil pump from the oil sump therethrough and the oil outlet tube communicating with the rotary shaft.

Preferably, the oil pump comprises: a pumping part for performing a pumping operation by the orbiting movement of the orbiting vane, the pumping part having a pump housing; a pump inlet port and a pump outlet port formed at opposite sides of the pump housing of the pumping part, respectively, the pump inlet port and the pump outlet port being horizontally disposed while the pump inlet port is coaxial with the pump outlet port; and an inlet side non-return valve and an outlet side non-return valve mounted on the pump inlet port and the pump outlet port, respectively.

Preferably, the pumping part comprises: a piston disposed in the pump housing for performing a vertical linear reciprocating movement by the orbiting movement of the orbiting vane and the resilient force of a spring disposed in the pump housing.

Preferably, the inlet side non-return valve comprises: a valve housing having one side connected to the pump inlet port of the pump housing and the other side connected to the oil inlet tube; and a valve stopper fixedly disposed at the outlet side in the valve housing, and the outlet side non-return valve comprises: a valve housing having one side connected to the pump outlet port of the pump housing and the other side connected to the oil outlet tube; and a valve stopper fixedly disposed at the outlet side in the valve housing.

Preferably, the inlet side non-return valve further comprises: a valve body disposed in the valve housing such that the valve body can be horizontally reciprocated, the valve body having a plurality of oil grooves formed along the outer circumferential part thereof, and the outlet side non-return valve further comprises: a valve body disposed in the valve housing such that the valve body can be horizontally reciprocated, the valve body having a plurality of oil grooves formed along the outer circumferential part thereof.

Preferably, the valve body of the inlet side non-return valve has a diameter greater than that of the oil inlet tube and that of the pump inlet port, and the valve body of the outlet side non-return valve has a diameter greater than that of the oil outlet tube and that of the pump outlet port.

Preferably, the oil-supplying unit further comprises: a propeller mounted at the entrance of the oil hole of the rotary shaft for increasing the flow rate of the oil supplied into the oil hole of the rotary shaft through the oil outlet tube.

Preferably, the oil-supplying unit further comprises: an oil separating plate disposed at the outlet side of the oil hole of the rotary shaft.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a longitudinal sectional view illustrating the overall structure of a conventional rotary-type orbiting vane compressor;

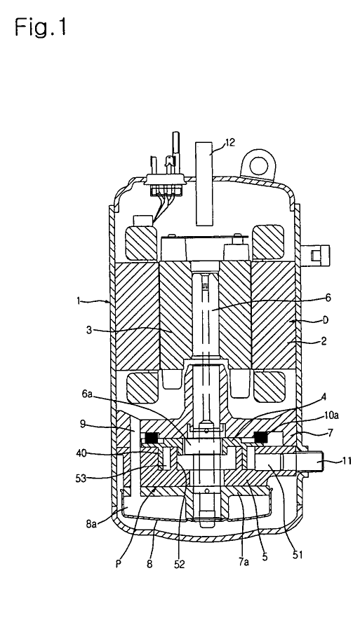

FIG. 2 is a plan view, in section, illustrating the compressing operation of the conventional orbiting vane compressor shown in FIG. 1;

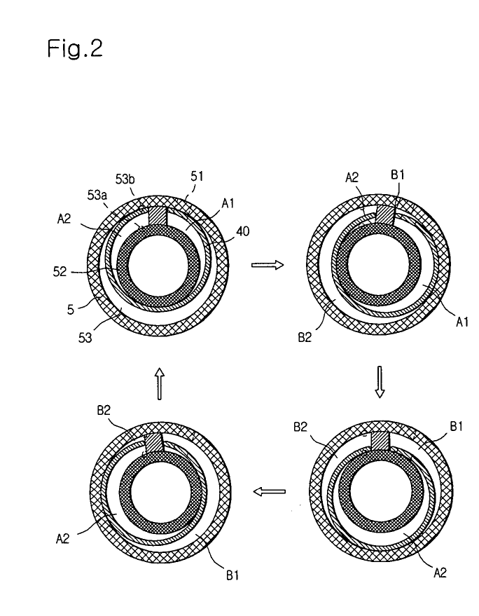

FIG. 3 is a longitudinal sectional view illustrating the overall structure of a horizontal type orbiting vane compressor according to the present invention;

FIG. 4 is a sectional view illustrating the oil pump of the horizontal type orbiting vane compressor according to the present invention shown in FIG. 3;

FIG. 5 is a perspective view illustrating the structure of the valve body of the oil pump shown in FIG. 4;

FIG. 6A is a sectional view illustrating the operation of the oil pump in a suction state; and

FIG. 6B is a sectional view illustrating the operation of the oil pump in a discharge state.

### DESCRIPTION OF THE PREFERRED EMBODIMENTS

Now, a preferred embodiment of the present invention will be described in detail with reference to the accompanying drawings.

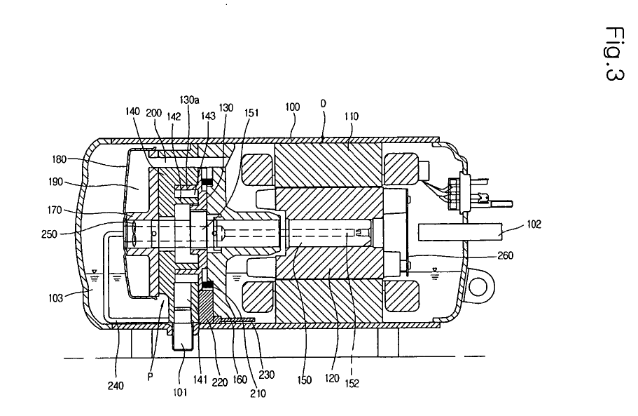

FIG. 3 is a longitudinal sectional view illustrating the overall structure of a horizontal type orbiting vane compressor according to the present invention. As shown in FIG. 3, the horizontal type orbiting vane compressor comprises: a hermetically sealed shell 100, which is horizontally disposed; a compression unit P disposed at one side in the shell 100; and a drive unit D disposed at the other side in the shell 100. The compression unit P and the drive unit D are connected to each other via a rotary shaft 150, which has an eccentric part 151.

The drive unit D comprises: a stator 110 fixedly disposed in the shell 100; and a rotor 120 disposed in the stator 110 for rotating the rotary shaft 150, which horizontally extends through the rotor 120, when electric current is supplied to the rotor 120.

The compression unit P comprises an orbiting vane 130 for performing an orbiting movement in a cylinder 140 by the eccentric part 151 of the rotary shaft 150. As the orbiting vane 130 performs the orbiting movement in the cylinder 140, refrigerant gas introduced into the cylinder 140 through an inlet port 141 is compressed. The cylinder 140 has an inner ring 142. Between the inner ring 142 and the inner wall of the cylinder 140 is defined an annular operation space 143. A wrap 130a of the orbiting vane 130 performs an orbiting movement in the operation space 143. As a result, compression chambers are formed at the inside and the outside of the wrap 130a, respectively.

At opposite sides of the compression unit P are disposed a main bearing 160 and a subsidiary bearing 170, which support opposite ends of the rotary shaft 150, respectively. The subsidiary bearing 170 has a discharge chamber 190, which is defined by a muffler 180. The discharge chamber 190 is connected to a pipe-shaped discharge channel 200, which extends horizontally through the compression unit P and the main bearing 160, such that the compressed refrigerant gas is discharged into the shell 1 through the discharge channel 200.

Below the orbiting vane 130 is disposed an oil-supplying unit. The oil-supplying unit comprises: an oil pump 220 for supplying oil from an oil sump 103 to the rotary shaft 150; and oil inlet and outlet tubes 230 and 240 disposed at opposite sides of the oil pump, respectively. The oil inlet tube 230 is mounted in the oil sump 103 for allowing oil to be introduced into the oil pump 220 from the oil sump 103 therethrough, and the oil outlet tube 240 communicates with the rotary shaft 150.

Unexplained reference numeral 101 indicates an inlet tube, 102 an outlet tube, and 210 an Oldham's ring for preventing rotation of the wrap 40 of the orbiting vane 4.

When electric current is supplied to the drive unit D, the rotor 120 of the drive unit D is rotated, and therefore, the rotary shaft 150, which horizontally extends through the rotor 120, is also rotated. As the rotary shaft 150 is rotated, the orbiting vane 130 attached to the eccentric part 151 of the rotary shaft 150 performs an orbiting movement.

As a result, the wrap 130a of the orbiting vane 130 performs an orbiting movement in the operation space 143 of the cylinder 140 to compress refrigerant gas introduced into the cylinder 140 through the inlet port 141 in the compression chambers formed at the inside and the outside of the wrap 130a, respectively. The compressed refrigerant gas is discharged into the discharge chamber 190 through inner and outer outlet ports (not shown) formed at the cylinder 140 and the subsidiary bearing 170. The discharged high-pressure refrigerant gas is guided into the shell 100 through the discharge channel 200. Finally, the compressed refrigerant gas is discharged out of the shell 100 through the outlet tube 102.

As the oil pump 220, which is disposed below the orbiting vane 130, is operated, oil is introduced into the oil pump 220 from the oil sump 103 through the oil inlet tube 230, and is then supplied to the rotary shaft 150, through which an oil hole 152 extends longitudinally, through the oil outlet tube 240. Preferably, a propeller 250 is mounted at the entrance of the oil hole 152 of the rotary shaft 150 for increasing the flow rate of the oil supplied into the oil hole 152 of the rotary shaft 150 through the oil outlet tube 240. Also, an oil separating plate 260 is disposed at the outlet side of the oil hole 152 of the rotary shaft 150.

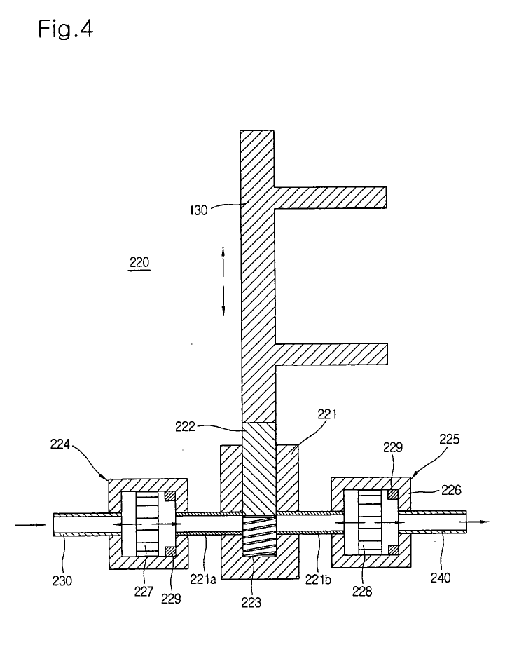

FIG. 4 is a sectional view illustrating the oil pump 220.

As shown in FIG. 4, the oil pump 220 is a reciprocating pump constructed such that a piston 222 performs a vertical linear reciprocating movement in a pump housing 221 by an orbiting movement of the orbiting vane 130 and the resilient force of a spring 223. The pump housing 221 is provided at opposite sides thereof with a pump inlet port 221a and a pump outlet port 221b, respectively. The pump inlet port 221a and the pump outlet port 221b are horizontally disposed while the pump inlet port 221a is coaxial with the pump outlet port 221b. On the pump inlet port 221a and the pump outlet port 221b are mounted an inlet side non-return valve 224 and an outlet side non-return valve 225, respectively.

The inlet side non-return valve 224 comprises: a valve housing 226 having one side connected to the pump inlet port 221a of the pump housing 221 and the other side connected to the oil inlet tube 230; a valve stopper 229 fixedly disposed at the outlet side in the valve housing 226; and a valve body 227 disposed in the valve housing 226 such that the valve body 227 can be horizontally reciprocated.

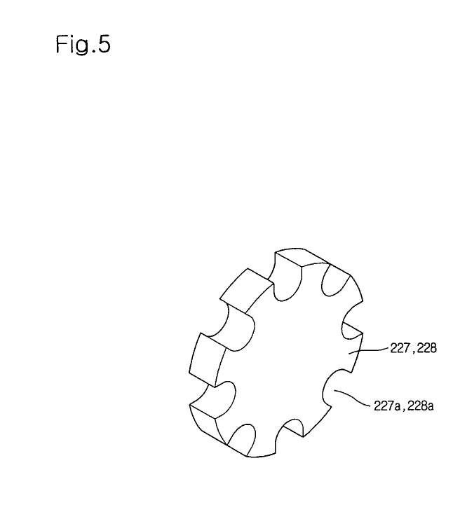

The valve body 227 has a diameter greater than that of the oil inlet tube 230 and that of the pump inlet port 221a. As shown in FIG. 5, the valve body 227 is formed in the shape of a disc having a plurality of oil grooves 227a formed along the outer circumferential part thereof. The oil inlet tube 230 and the pump inlet port 221a are horizontally disposed while the oil inlet tube 230 is coaxial with the pump inlet port 221a.

The outlet side non-return valve 225 comprises: a valve housing 226 having one side connected to the pump outlet port 221b of the pump housing 221 and the other side connected to the oil outlet tube 240; a valve stopper 229 fixedly disposed at the outlet side in the valve housing 226; and a valve body 228 disposed in the valve housing 226 such that the valve body 228 can be horizontally reciprocated.

The valve body 228 has a diameter greater than that of the oil outlet tube 240 and that of the pump inlet port 221b. As shown in FIG. 5, the valve body 228 is formed in the shape of a disc having a plurality of oil grooves 228a formed along the outer circumferential part thereof. The oil outlet tube 240 and the pump outlet port 221b are horizontally disposed while the oil outlet tube 240 is coaxial with the pump outlet port 221b.

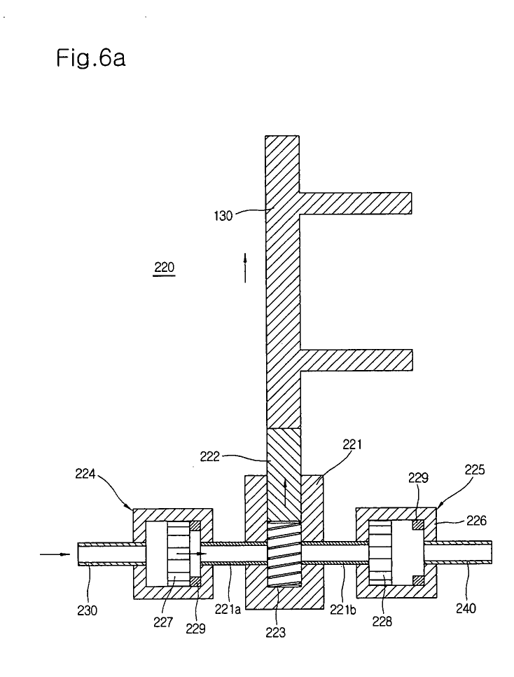

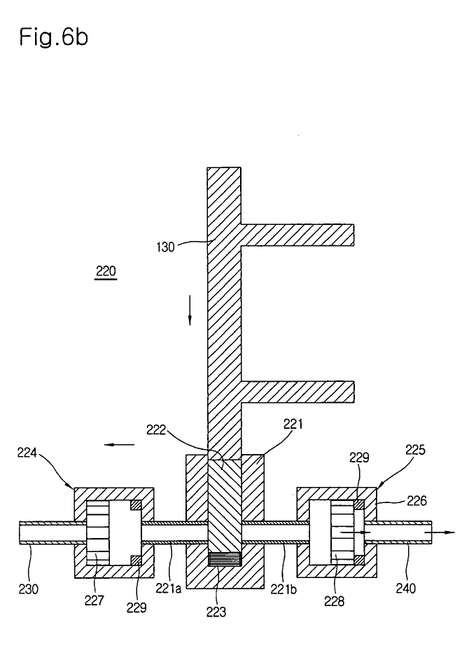

FIGS. 6A and 6B illustrate the operation of the oil pump 220. FIG. 6A is a sectional view illustrating the operation of the oil pump 220 in a suction state, and FIG. 6B is a sectional view illustrating the operation of the oil pump 220 in a discharge state.

The piston 222, which is disposed under the orbiting vane 130 while being in contact with the orbiting vane 130, is moved downward by the orbiting vane 130 performing an orbiting movement, and is then moved upward by the spring 223 disposed in the pump housing 221 for resiliently pushing the piston 222 upward. In this way, the piston 222 performs a vertical linear reciprocating movement in the pump housing 221 by the orbiting movement of the orbiting vane 130 and the resilient force of the spring 223, and suction pressure and discharge pressure are created in the pump housing 221 by the vertical linear reciprocating movement of the piston 222.

When the piston 222 is moved upward, as shown in FIG. 6A, the suction pressure is created in the pump housing 221, and therefore, the valve body 227 of the inlet side non-return valve 224 and the valve body 228 of the outlet side non-return valve 225 are moved toward the pump inlet port 221a and the pump outlet port 221b of the pump housing 221, respectively. As a result, the valve body 228 of the outlet side non-return valve 225 is brought into tight contact with the valve housing 226 of the outlet side non-return valve 225, and therefore, the pump outlet port 221b of the pump housing 221 is closed. However, the valve body 227 of the inlet side non-return valve 224 is not brought into contact with the valve housing 226 of the inlet side non-return valve 224 due to the valve stopper 229, and therefore, the pump inlet port 221a of the pump housing 221 is not closed.

Consequently, oil is introduced into the pump housing 221 from the oil sump 103 (see FIG. 3) through the oil inlet tube 230, the inlet side non-return valve 224, and the pump inlet port 221a.

When the piston 222 is moved downward, as shown in FIG. 6B, the discharge pressure is created in the pump housing 221, and therefore, the valve body 227 of the inlet side non-return valve 224 and the valve body 228 of the outlet side non-return valve 225 are moved toward the oil inlet tube 230 and the oil outlet tube 240, respectively. As a result, the valve body 227 of the inlet side non-return valve 224 is brought into tight contact with the valve housing 226 of the inlet side non-return valve 224, and therefore, the oil inlet tube 230 is closed. However, the valve body 228 of the outlet side non-return valve 225 is not brought into contact with the valve housing 226 of the outlet side non-return valve 225 due to the valve stopper 229, and therefore, the oil outlet tube 240 is not closed.

Consequently, oil is supplied into the oil hole 152 of the rotary shaft 150 (see FIG. 3) from the pump housing 221 through the pump outlet port 221b, the outlet side non-return valve 225, and the oil outlet tube 240.

As apparent from the above description, the present invention provides a horizontal type orbiting vane compressor that is capable of forming compression chambers at the inside and the outside of a wrap of an orbiting vane as the wrap performs an orbiting movement in an operation space defined in a cylinder. Consequently, the present invention has the effect of accomplishing miniaturization of an outdoor unit of an air conditioner when the horizontal type orbiting vane compressor is installed in the outdoor unit.

Furthermore, the oil is forcibly supplied into the oil hole of the rotary shaft by the pumping operation accomplished through the orbiting movement of the orbiting vane. Consequently, the present invention has the effect of accomplishing smooth and reliable oil supply.

In addition, the propeller is mounted at the entrance of the oil hole of the rotary shaft. Consequently, the present invention has the effect of increasing the flow rate of the oil supplied into the oil hole of the rotary shaft through the oil outlet tube.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

What is claimed is:

1. A horizontal type orbiting vane compressor comprising:
a horizontally disposed shell having an inlet tube and an outlet tube;
a compression unit disposed in the shell at one side of a horizontally disposed rotary shaft such that the compression unit is rotated by a drive unit for compressing refrigerant gas; and
an oil-supplying unit for supplying oil from an oil sump to an oil hole extending through the rotary shaft by an orbiting movement of an orbiting vane in the compression unit.

2. The compressor as set forth in claim 1, wherein the rotary shaft is disposed such that opposite ends of the rotary shaft are rotatably supported by a main bearing and a subsidiary bearing, which are disposed at opposite sides of the compression unit, respectively, and further comprising:
a muffler disposed adjacent to outlet ports of the subsidiary bearing; and
a discharge chamber defined by the muffler.

3. The compressor as set forth in claim 2, further comprising:
a discharge channel formed inside the muffler, the discharge channel extending though the compression unit and communicating with the discharge chamber.

4. The compressor as set forth in claim 1, wherein the compression unit comprises:
a cylinder having an operation space defined between an inner wall of the cylinder and an inner ring; and
an orbiting vane having a wrap disposed in the operation space of the cylinder for performing an orbiting movement.

5. The compressor as set forth in claim 4, wherein the operation space is divided into inner and outer compression chambers by the wrap.

6. The compressor as set forth in claim 5, wherein the cylinder has a pair of outlet ports, which communicate with the inner and outer compression chambers, respectively.

7. The compressor as set forth in claim 1, wherein the oil-supplying unit comprises:
an oil pump for supplying oil from an oil sump to the rotary shaft; and
oil inlet and outlet tubes disposed at opposite sides of the oil pump, respectively,
the oil inlet tube being mounted in the oil sump for allowing oil to be introduced into the oil pump from the oil sump therethrough and the oil outlet tube communicating with the rotary shaft.

8. The compressor as set forth in claim 7, wherein the oil pump comprises:
a pumping part for performing a pumping operation by the orbiting movement of the orbiting vane, the pumping part having a pump housing;
a pump inlet port and a pump outlet port formed at opposite sides of the pump housing of the pumping part, respectively, the pump inlet port and the pump outlet port being horizontally disposed while the pump inlet port is coaxial with the pump outlet port; and
an inlet side non-return valve and an outlet side non-return valve mounted on the pump inlet port and the pump outlet port, respectively.

9. The compressor as set forth in claim 8, wherein the pumping part comprises:
a piston disposed in the pump housing for performing a vertical linear reciprocating movement by the orbiting movement of the orbiting vane and the resilient force of a spring disposed in the pump housing.

10. The compressor as set forth in claim 8, wherein the inlet side non-return valve comprises:
a valve housing having one side connected to the pump inlet port of the pump housing and the other side connected to the oil inlet tube; and
a valve stopper fixedly disposed at the outlet side in the valve housing.

11. The compressor as set forth in claim 10, wherein the inlet side non-return valve further comprises:
a valve body disposed in the valve housing such that the valve body can be horizontally reciprocated, the valve body having a plurality of oil grooves formed along the outer circumferential part thereof.

12. The compressor as set forth in claim 11, wherein the valve body of the inlet side non-return valve has a diameter greater than that of the oil inlet tube and that of the pump inlet port.

13. The compressor as set forth in claim 12, wherein the valve body of the inlet side non-return valve is formed in the shape of a disc.

14. The compressor as set forth in claim 8, wherein the outlet side non-return valve comprises:
a valve housing having one side connected to the pump outlet port of the pump housing and the other side connected to the oil outlet tube; and
a valve stopper fixedly disposed at the outlet side in the valve housing.

15. The compressor as set forth in claim 14, wherein the outlet side non-return valve further comprises:
a valve body disposed in the valve housing such that the valve body can be horizontally reciprocated, the valve body having a plurality of oil grooves formed along the outer circumferential part thereof.

16. The compressor as set forth in claim 15, wherein the valve body of the outlet side non-return valve has a diameter greater than that of the oil outlet tube and that of the pump outlet port.

17. The compressor as set forth in claim 16, wherein the valve body of the outlet side non-return valve is formed in the shape of a disc.

18. The compressor as set forth in claim 7, wherein the oil-supplying unit further comprises:
a propeller mounted at the entrance of the oil hole of the rotary shaft for increasing the flow rate of the oil supplied into the oil hole of the rotary shaft through the oil outlet tube.

19. The compressor as set forth in claim 7, wherein the oil-supplying unit further comprises:
an oil separating plate disposed at the outlet side of the oil hole of the rotary shaft.
